(19) United States
(12) Patent Application Publication
(10) Pub. No.: US 2006/0087058 A1
(43) Pub. Date: Apr. 27, 2006

(54) Thermoforming etching process

(75) Inventor: Michael A. Hooker, Sheboygan, WI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Emerald Graphics Corporation

(21) Appl. No.: 10/973,588

(22) Filed: Oct. 26, 2004

(51) Int. Cl. B23K 26/36; B32B 3/26; B29C 51/42; B29C 45/00

(52) U.S. Cl. 264/400; 264/139; 264/134; 264/544; 264/328.1

(57) ABSTRACT

A method for producing a molded and laser etched component includes providing a substrate material having a first side and a second side, providing a first layer of coating upon a portion of at least a select one of the first side and the second side, and providing a second layer of coating upon a select one of the first side and the second side and overlapping at least a portion of the first layer of coating. The method further includes molding the sheet to a component, and etching a portion of the second layer of coating, thereby exposing a portion of the first layer of coating and forming a graphic display.

### BACKGROUND OF THE INVENTION

The present invention relates to a method for creating graphic displays on molded components, and in particular to a method for producing laser etched graphic displays upon components.

Back-lit graphic displays are used in a wide variety of applications, such as interior displays for vehicles, industrial equipment, audio equipment, and the like. These displays typically include a console or panel member having a plurality of apertures extending therethrough that are covered by tinted or colored sheets of material. A light source located behind the console provides a back-lit effect, thereby providing the operator with necessary information as to the purpose or function of the associated control, lever, knob, etc.

Heretofore, known methods of manufacturing a back-lit component have included screen printing a first color onto a substrate, wherein the first color is imprinted on the substrate to define a given graphic. This process then includes covering the graphic with various colors on the same side of the substrate as the first color layer. The substrate is then affixed to a given component. While this printing technique does provide a low-cost method for providing a back-lit component, graphics created in this manner can be less well defined than comparable laser etching processes. Moreover, it is often difficult to utilize this particular method in areas on or proximate a radiused edge.

A typical laser-etching process includes masking apertures of a pre-molded component with layers of colored translucent material, and then covering the component and the material with at least one layer of paint. Drawbacks to the laser etching process as known includes the relatively high cost of the painting process, as well as the capital investment required into the painting systems. Other drawbacks include the inability of the process to compensate for varying illumination due to the intensity and/or location of the illuminating light source.

Therefore, a method for manufacturing a back-lit component is desired that is relatively low-cost, provides crisp and bright graphics, allows such graphics to be placed on or near radiused edges of the component, eliminates the expensive requirement of painting the associated component, allows the associated graphic to be used in conjunction with textured surfaces of the component, and allows simultaneous harmonization of the lighting intensities as viewed through the component when in use.

### SUMMARY OF THE INVENTION

One aspect of the present invention is to provide a method for producing a molded and laser etched component that includes providing a substrate sheet material having a first side and a second side, providing a first layer of coating upon a portion of at least a select one of the first side of the second side, and providing a second layer of coating upon a selected one of the first side and the second side and overlapping at least a portion of the first layer of coating. The method further includes molding the sheet to a component, and etching a portion of the second layer of coating, thereby exposing a portion of the first layer of coating and forming a graphic display.

The present inventive method for manufacturing a back-lit component is relatively low-cost, provides crisp and bright graphics, allows such graphics to be placed on or near radiused edges of the component, eliminates the expensive requirement of painting the associated component, allows the associated graphic to be used in conjunction with textured surfaces of the component, and allows simultaneous harmonization of the lighting intensities as viewed through the component when in use.

These and other advantages of the present invention will be further understood and appreciated by those skilled in the art by reference to the following specification, claims and appended drawings.

### BRIEF DESCRIPTION OF THE DRAWINGS

FIG. 1 is a perspective view of a component with a graphic display embodying the present invention;

FIG. 2 is a perspective view of a substrate member with layers of differently colored translucent covering materials printed thereon;

FIG. 3 is a cross-sectional side view of the substrate member, taken along the line III-III, FIG. 2;

FIG. 4 is a top plan view of a formed cover including dashed trim lines;

FIG. 5 is an exploded perspective view of the substrate member and a component; and

FIG. 6 is a systems flow chart of the thermoforming etching process.

### DETAILED DESCRIPTION OF THE PREFERRED EMBODIMENTS

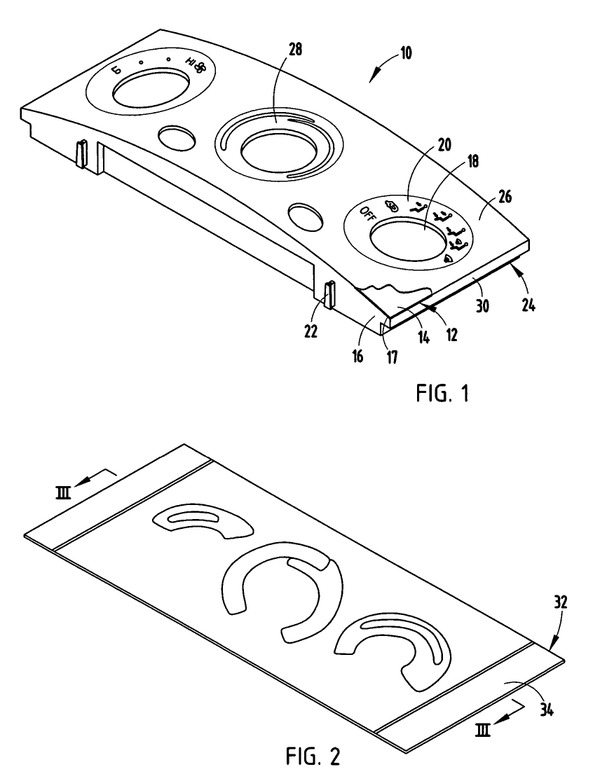

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

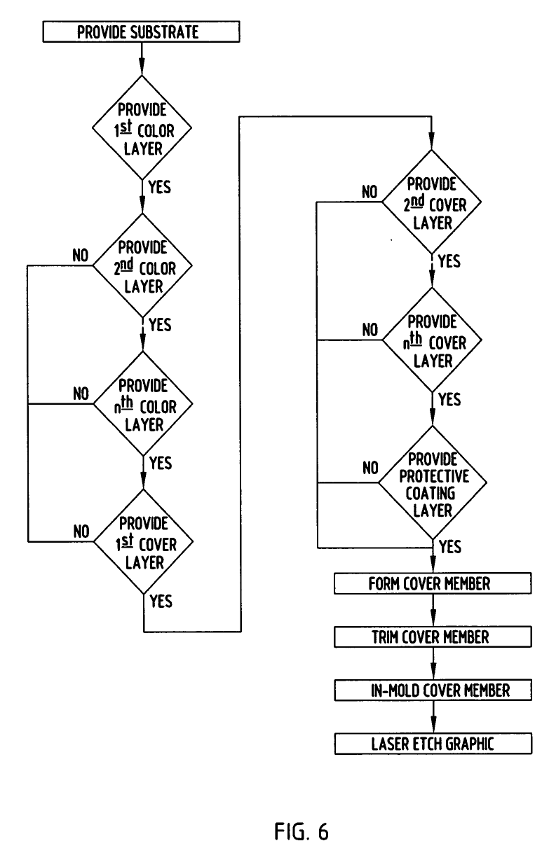

The reference numeral 10 (FIG. 1) generally designates a console or panel insert assembly embodying a component as manufactured by the method of the present invention, the steps of which are systematically set forth in FIG. 6. In the illustrated example, the panel insert 10 includes a panel insert 12 having an arcuate top surface 14, a plurality of sidewalls 16 extending orthogonally from the top surface 14, and beveled corners 17 blending the top surface 14 with the sidewalls 16, and a plurality of control or knob receiving apertures 18 extending through the top surface 14. At least some of the control-receiving apertures 14 are circumferentially surrounded by inwardly-extending bevels 20. The panel insert 12 further includes a plurality of mechanical-type fasteners 22 adapted to fasten the panel insert assembly within a dashboard or console of an associated vehicle.

The panel insert assembly 10 further includes a cover member 24 that is in-molded with the panel insert 12 and covers the top surface 14 thereof, as described below. The cover member 24 includes an outer surface 26, a plurality of control-receiving apertures 28 coaligned with the control-receiving apertures 18 of the panel insert 12, and a plurality or rounded edges 30 that closely cooperate and are formed about the corners 17 of the panel insert 12.

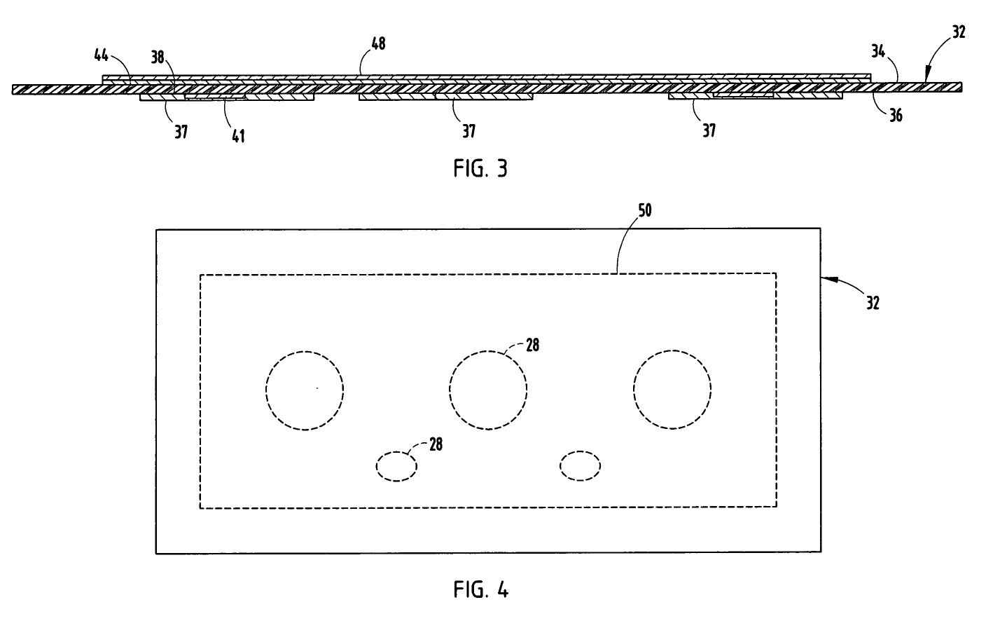

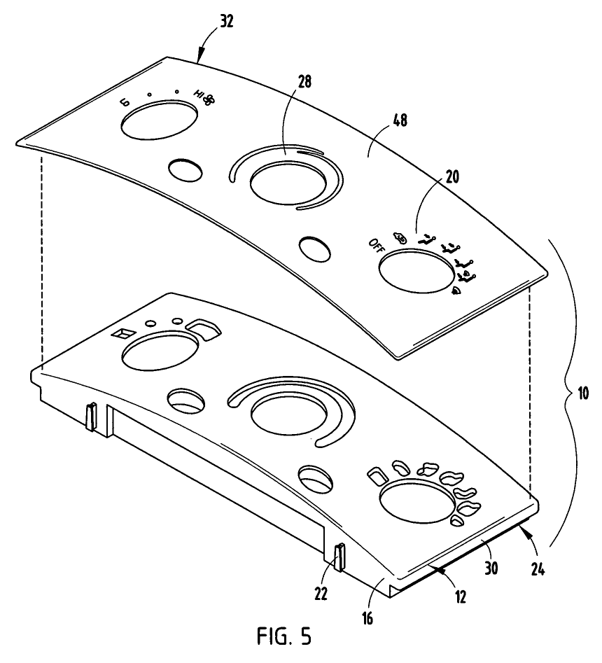

The subject method for producing the panel insert assembly 10 includes first providing a substrate sheet 32 (FIGS. 2 and 3) that is preferably translucent or substantially transparent, but may be any color. The substrate sheet 32 is formed from a thermoformable-type material, such as polycarbonate film or the like. A first layer of coating material 37 is provided upon a given portion or first portion 38 of the bottom surface 36. In the illustrated example, the first layer of coating 37 is an ink that is screen printed upon the bottom surface 36. However, other conventional printing and application methods can instead be employed if desired, and the ink may be any color desired. A second layer of coating 40 is then applied to a given second portion 41 of the bottom surface 36. As illustrated, the second portion 41 partially overlaps the first portion 38. The overlapping technique can be applied for various reasons, including to effect the ultimate light intensity as seen by the operator of the panel insert assembly 10 during operation within the vehicle, and/or to mix or blend multiple colors together. Additional layers of coatings of similar or different color can be applied to the bottom surface 36 of the substrate sheet 32 as required. Preferably, the first and second layers of coating 37, 40, and any subsequently-applied layer of coating, is formed of a plurality of dots on the substrate 32. The dots can be any shape, can be the same or different shapes, and can be in any density and in any pattern on the substrate sheet 32 depending upon the type of coating material employed. The specifics of how the dots of the layers of the coating 37, 40 are formed and employed are disclosed in more detail in U.S. Pat. No. 6,770,324, entitled METHOD OF FORMING A NON-UNIFORM PROTECTIVE COATING ON A FLEXIBLE SUBSTRATE, and U.S. patent application Ser. No. 10/873,731, entitled A NON-UNIFORM PROTECTIVE COATING ON A FLEXIBLE SUBSTRATE, the contents of which are incorporated in their entirety. After application of the first and second layers of coating 37, 40, and subsequent layer of coating(s), are applied to the substrate sheet 32, the first and second layer of coating 37, 40 are cured by exposure to ultraviolet light, although other curing methods are possible (including exposure to air and/or heat) depending upon the type of protective coating material used. Once cured, the dots forming the layers of coating 37, 40 enable the substrate sheet 32 to be flexed and formed without damage to the layers of coating 37, 40.

Preferably, an outer layer of coating 44 is then applied to the top surface 34 of the substrate sheet 32 in a manner similar to the application of the first and second layers of coating 37, 40 so as to provide a uniform appearance to the outer or exposed surface or panel insert assembly. While it is preferable that the outer layer of coating 44 is applied to substantially all of the top surface 34 of the substrate sheet 32, the outer layer of coating 44 is at least applied at least partially over the first portion 38 and the second portion 42 as covered by the first layer of coating 37 and the second layer of coating 34, respectively. The outer layer of coating 44 is preferably a black mat color, however, coatings of other colors may be substituted therefore. An additional layer of protective coating 48, such as a clear urethane or clear, painted or printed polyester, is then placed over the outer layer of coating 44 to protect the same from degradation due to normal wear, scratching and other damage.

Subsequent to coating the substrate sheet 32 with the multiple coating layers 37, 40, 48, the sheet 32 is placed within a thermal-forming die and formed so as to at least partially conform with the shape of the panel insert 12. The formed sheet 32 is the trimmed along a given pattern, represented by the dashed lines 50 (FIG. 4), so as to include the control-receiving apertures 28 and to include the general configuration of the associated panel insert 12. Subsequent to trimming, the sheet 32 is placed within a die mold and is in-molded with the panel insert 12 as the material to form the panel insert 12 is injected into the mold.

A laser-etching process is then utilized to etch-away the protective coating 48, if employed, and the outer layer of coating 44 from the top surface 34 of the substrate sheet 32 thereby exposing the layers of coating 37, 40 and forming a graphic design. Preferably, a laser etching system utilizing a yttrium aluminum garnet (ND [symbol] YAG)) or CO²-type laser is used, however, other suitable etching processes may be substituted therefore. The panel insert assembly 10 is assembled within a vehicle dashboard or console panel that includes a light source that illuminates and provides a back-light to the panel insert assembly 10.

In the foregoing description, it will be readily appreciated by those skilled in the art that modifications may be made to the invention without departing from the concepts disclosed herein. Such modifications are to be included in the foregoing claims, unless these claims by their language expressly state otherwise.

The invention claimed is:

1. A method for producing a molded and laser etched component, comprising:
providing a substrate sheet material having a first side and a second side;
providing a first layer of coating upon a portion of at least a select one of the first side and the second side;
providing a second layer of coating upon a select one of the first side and the second side and overlapping at least a portion of the first layer of coating;
molding the sheet to a component; and
etching a portion of the second layer of coating, thereby exposing a portion of the first layer of coating and forming a graphic display.

2. The method of claim 1, wherein the step of providing the substrate sheet comprises providing a thermoformable sheet.

3. The method of claim 2, further comprising:
forming the thermoformable sheet into a non-planar form prior to the molding step.

4. The method of claim 3, wherein the step of forming the thermoformable sheet includes heating the thermoformable sheet to a predetermined temperature.

5. The method of claim 4, wherein the step of forming the thermoformable sheet includes applying an increased fluid pressure to a select one of the first side and the second side of the thermoformable sheet.

6. The method of claim 5, wherein the step of forming the thermoformable sheet includes applying a decreased fluid pressure to the side of the thermoformable sheet opposite the increased fluid pressure.

7. The method of claim 3, wherein the step of etching comprises laser etching.

8. The method of claim 7, wherein the step of providing the first layer of coating comprises a screen-printing process.

9. The method of claim 8, wherein the step of providing the second layer of coating comprises a screen-printing process.

10. The method of claim 9, wherein the molding step includes forming the component via an injection molding process.

11. The method of claim 1, wherein the step of etching comprise laser etching.

12. The method of claim 1, wherein the step of providing the first layer of coating comprises a screen-printing process.

13. The method of claim 12, wherein the step of providing the second layer of coating comprises a screen-printing process.

14. The method of claim 1, wherein the molding step includes forming the component via an injection molding process.

15. The method of claim 1, wherein the step of providing the first layer of coating includes providing the first layer of coating on the first side of the substrate sheet, and wherein the step of providing the second layer of coating includes providing the second layer of coating on the second side of the substrate.

16. The method of claim 1, further including:
providing a third layer of coating on the same side of the substrate sheet material as the first layer of coating material, wherein a color of the third layer of coating is different from a color of the first layer of coating material.

17. The method of claim 16, wherein the step of providing the third layer of coating includes providing the third layer of coating such that the third layer of coating overlaps at least a portion of the first coating material.

18. The method of claim 1, wherein the step of providing the first layer of coating includes providing the first layer of coating such that a thickness of the first layer of coating varies between a first portion and a second portion.

19. The method of claim 1, further including:
providing a layer of protective coating over the second layer of coating.
